(19) United States
(12) Patent Application Publication
(10) Pub. No.: US 2007/0106671 A1
(43) Pub. Date: May 10, 2007

(54) Computer-readable recording medium storing data collection program and data collection apparatus

(75) Inventors: Hirofumi Uchida, Kawasaki (JP); Masaharu Koyabu, Kawasaki (JP); Kazuo Kayamoto, Kawasaki (JP); Toshikazu Sugita, Kawasaki (JP); Kenichiro Miyamoto, Oita (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/376,125

(22) Filed: Mar. 16, 2006

(30) Foreign Application Priority Data
Nov. 8, 2005 (JP) 2005-322985

(51) Int. Cl. G06F 17/30

(52) U.S. Cl. 707/10

(57) ABSTRACT

A computer-readable recording medium storing a data collection program for easily performing a process to collect data from a plurality of core systems at desired timing, and combine and analyze the data and data in a local database. An access request decomposer determines at least one remote database to be accessed, based on an access request accepted by an information management unit, and decomposes the access request into remote access requests each for accessing each of the remote databases. An access unit accesses the remote databases based on the remote access requests created by the access decomposer and extracts data from the remote databases. An aggregation unit aggregates the data extracted by the access unit, and then the aggregation result is displayed.

### CROSS-REFERENCE TO RELATED APPLICATIONS

This application is based on, and claims priority to, Japanese Application No. 2005-322985, filed Nov. 8, 2005, in Japan, and which is incorporated herein by reference.

### BACKGROUND OF THE INVENTION

(1) Field of the Invention

This invention relates to a computer-readable recording medium storing a data collection program for aggregation, analysis, etc. of data in a data warehouse and a data collection apparatus. More particularly, this invention relates to a computer-readable recording medium storing a data collection program for collecting and processing data that is dispersed in a plurality of servers and a data collection apparatus.

(2) Description of the Related Art

In a network system where databases are dispersed in a wide area, an information server is used for using information being registered in the databases. For example, a corporation having sales bases all over a country constructs a core system at each sales base. In the core system, various data including the sales records of the shops in its territory is saved in a database. An information server being connected to the core systems over a network periodically accesses the core systems to collect, combine and save data in a local database. Then the information server analyzes the data in order to, for example, calculate the total sales revenue for every month.

By the way, data to be used by the information server needs to be locally stored in a predetermined format in the information server. In general, data collected from the core systems is processed with Extract/Transform/Load (ETL) tool or the like, and saved in a database of the information server. That is, the information server performs data analysis on only data being stored in its local database.

Each core system needs to process daytime transactions with priority. Therefore, the information server collects data in night batch processing. For example, data is processed for the information system every other day, every week, or every month. That is to say, it needs some time to use and analyze recent data by using the information server.

When a user needs to refer to latest data in a core system, he/she directly acquires the data from the core system with a DataBase Management System (DBMS). Since the data has not been processed by the information server, the user should analyze the data with spreadsheet software or the like with his/her terminal device.

Therefore, various techniques are considered for accessing a database from a user's terminal device. As an example, there provided is a technique for simultaneously accessing some databases from a user's terminal device (for example, refer to Japanese Patent Application Laid-open Publication No. 4-112246). In this connection, to access some databases, the user should authenticate his/her account for each database. For this purpose, a technique for easily setting user accounts for corresponding databases has been proposed (for example, refer to Japanese Patent Application Laid-open Publication No. 7-98669). In addition, a technique for acquiring data from a core system according to a data search request has been proposed (for example, refer to Japanese Patent Application Laid-open Publication No. 2003-150594).

However, to acquire data from core systems, a user has to individually access databases of the core systems from his/her terminal device. Therefore, accessing a large number of databases is very troublesome work.

Further, even if the user can directly obtain data from the core systems, he/she can use only the data acquired from the core systems for analysis. In other words, the user cannot combine and analyze data in the information server and the data in the core systems.

### SUMMARY OF THE INVENTION

This invention has been made in view of the foregoing and intends to provide a computer-readable recording medium storing a data collection program for easily collecting data from a plurality of core systems at desired timing, and combining and analyzing the data and data in a local database, and a data collection apparatus.

To accomplish this object, there provided is a computer-readable recording medium storing a data collection program for aggregating data being dispersed on a network. This data collection program being stored in this recording medium causes a computer to function as: a data information memory for storing remote data information on data items of stored data of a plurality of remote databases being connected over the network; an information management unit for displaying accessible data items based on the remote data information being stored in the data information memory, and accepting an access request specifying a target data item to be accessed; an access request decomposer for determining at least one remote database to be accessed, based on the access request accepted by the information management unit, and decomposing the access request into remote access requests each for accessing each remote database to be accessed; an access unit for accessing the remote databases according to the remote access requests created by the access request decomposer, and extracting data from the remote databases; and an aggregation unit for aggregating the data extracted by the access unit and displaying an aggregation result.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows an outline view of this embodiment.

FIG. 2 shows an example of a system configuration of this embodiment.

FIG. 3 shows an example of a hardware configuration of an information server according to this embodiment.

FIG. 4 is a functional block diagram of the information server.

FIG. 5 is a functional block diagram of a central server.

FIG. 6 is a flowchart of a data aggregation process to be performed by the information server.

FIG. 7 is a flowchart of a central server's process.

FIG. 8 shows a data selection screen to be displayed on a client.

FIG. 9 shows a screen where sales record of sales record table is selected.

FIG. 10 shows an analysis result screen.

FIG. 11 is a conceptual view showing an aggregation status of latest data.

### DESCRIPTION OF THE PREFERRED EMBODIMENTS

A preferred embodiment of this invention will be described with reference to the accompanying drawings.

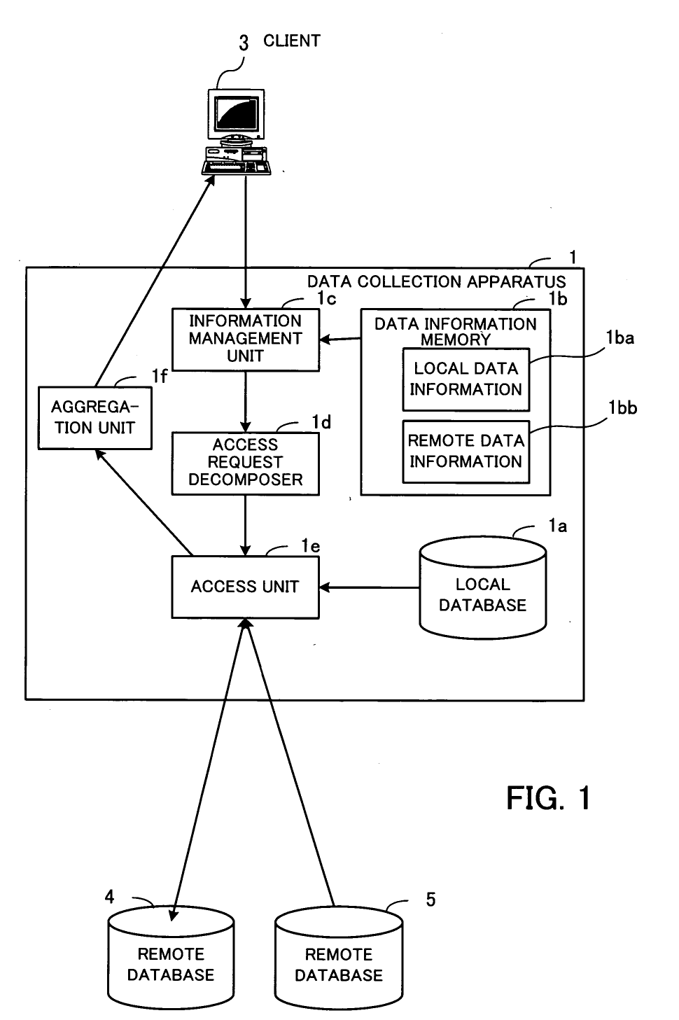

FIG. 1 shows an outline of this embodiment. A system according to the embodiment comprises a data collection apparatus 1, a client 3 and remote databases 4 and 5.

The data collection apparatus 1 is a computer for offering data aggregation service to a user using the client 3. The client 3 is a computer which is used by the user and displays a result of data aggregation. The remote databases 4 and 5 are databases accessible from the data collection apparatus 1 over a network.

The data collection apparatus 1 comprises a local database 1a, a data information memory 1b, an information management unit 1c, an access request decomposer 1d, an access unit 1e, and an aggregation unit 1f.

The local database 1a is used to store data that is collected from the remote databases 4 and 5 at prescribed timing. For example, data is collected from the remote databases 4 and 5 and is saved in the local database la about once a week.

The data information memory 1b is used to store local data information 1ba and remote data information 1bb. The local data information 1ba is information on the data items of data being stored in the local database 1a. The remote data information 1bb is information on the data items of data being stored in the remote databases 4 and 5 that are connected over the network.

The information management unit 1c displays on the screen of the client 3 accessible data items based on the local data information 1ba and the remote data information 1bb being stored in the data information memory 1b. In addition, the information management unit 1c accepts an access request specifying a target data item to be accessed, from the client 3.

The access request decomposer 1d detects at least one database to be accessed, based on an access request accepted by the information management unit 1c. When the access request is to access the remote databases 4 and 5, the access request decomposer 1d decomposes the access request into remote access requests each for accessing each of the remote databases.

The access unit 1e accesses the local database 1a and collects data when an access request specifies the local database 1a. When an access request specifies the remote databases 4 and 5, on the other hand, the access unit 1e accesses the remote databases 4 and 5 according to remote access requests, which are created by the access request decomposer 1d, and extracts data from the remote databases 4 and 5.

The aggregation unit 1f aggregates data extracted by the access unit 1e and displays an aggregation result on the screen of the client 3.

According to such a system as described above, the information management unit 1c displays on the client 3 accessible data items based on the local data information 1ba and the remote data information 1bb being stored in the data information memory 1b. When a user specifies a desired data item for data aggregation, with the client 3, the client 3 transmits an access request specifying the data item to the data collection apparatus 1. The data collection apparatus 1 accepts the access request at the information management unit 1c.

Then the access request decomposer 1d determines at least one database to be accessed, based on the access request accepted by the information management unit 1c. When the remote databases 4 and 5 are to be accessed, the access request decomposer 1d decomposes the access request into remote access requests each for accessing each of the remote databases.

The access unit 1e accesses the local database 1a when the access request specifies the local database 1a, and extracts data. On the other hand, when the access request decomposer 1d creates remote access requests, the access unit 1e accesses the remote databases 4 and 5 according to the remote access requests, and extracts data from the remote databases 4 and 5. Then the data aggregation unit if aggregates the data extracted by the access unit 1e, and displays an aggregation result on the screen of the client 3.

Since an access request to remote databases is decomposed into remote access requests each for accessing each remote database as described above, the user is not necessary to make an access command to each remote database, which allows easy data collection work. In addition, since a data access request to the local database and a data access request to the remote databases can be made in the same way, the data already collected and stored in the local database and the data that is not collected and exists in the remote databases can be combined and analyzed easily.

By applying the data collection function as shown in FIG. 1 to a system that performs analysis on data collected from core systems, not only fixed data in a data warehouse but also real-time data can be effectively used. That is to say, a data search/aggregation/report system which enables immediate use/analysis of all of data that is created in various transaction processes can be realized.

By the way, data in remote databases can be collected via a central server. In this case, the central server is designed to be capable of processing the data. If such a central server is provided in a system having a plurality of devices that perform data aggregation, it is unnecessary to configure each aggregation device with a data processing function.

Now the embodiment will be described in detail in terms of an example of a system in which data is collected via a central server.

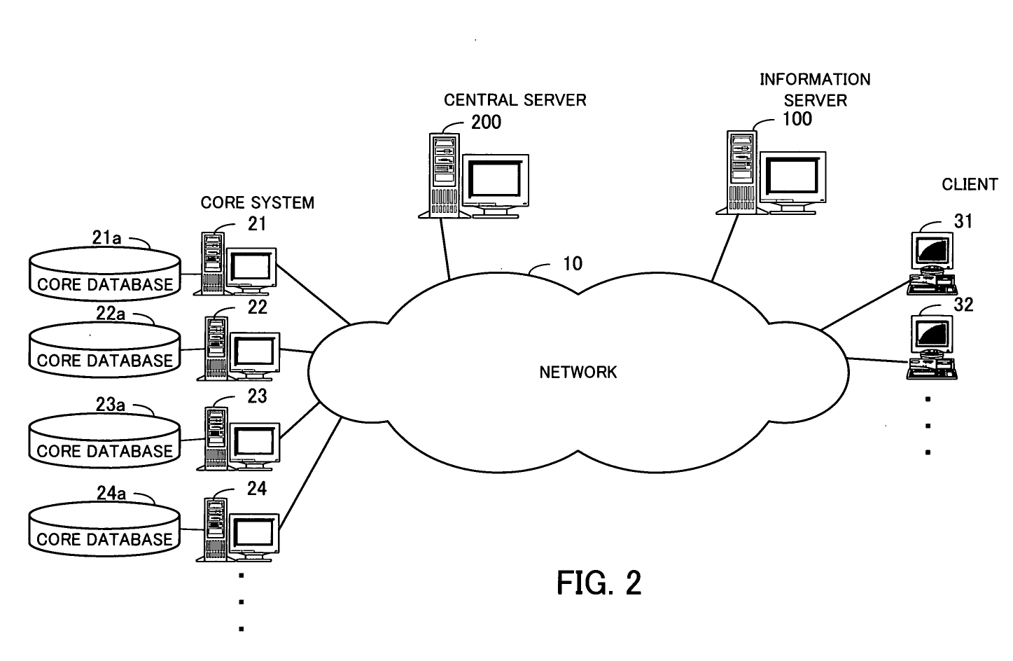

FIG. 2 shows a system configuration according to this embodiment. As shown in this figure, a plurality of core systems 21, 22, 23, 24, . . . are connected to each other over a network 10. The core systems 21, 22, 23, 24, . . . have core databases 21a, 22a, 23a, 24a, . . . , respectively. The core databases 21a, 22a, 23a, 24a, . . . store data treated by the core systems 21, 22, 23, 24, . . . , respectively.

The network 10 is connected to an information server 100, a central server 200, and clients 31, 32, . . . . The information server 100 is a computer to collect and analyze data from the core systems 21, 22, 23, 24, . . . . The central server 200 is a computer to obtain latest data from the core systems 21, 22, 23, 24, . . . in response to a request from the information server 100. The clients 31, 32, . . . are computers to be used by users. A user can access the information server 100 and receive an analysis result of various data, by using a client 31, 32, . . . .

Note that the functions of the data collection apparatus 1 of FIG. 1 are provided in the information server 100. The information server 100 has a function of analyzing collected data, as well as a function of collecting data from the core systems 21, 22, 23, 24, . . . .

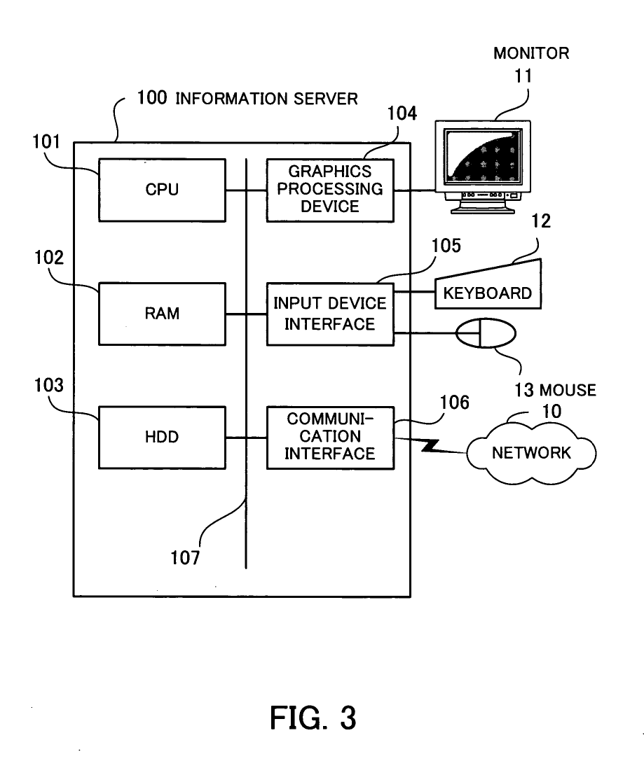

FIG. 3 shows a hardware configuration of the information server to be used in this embodiment. The information server 100 is entirely controlled by a Central Processing Unit (CPU) 101. Connected to the CPU 101 via a bus 107 are a Random Access Memory (RAM) 102, a Hard Disk Drive (HDD) 103, a graphics processing device 104, an input device interface 105, and a communication interface 106.

The RAM 102 temporarily stores at least part of the Operating System (OS) program and application programs to be executed by the CPU 101. In addition, the RAM 102 stores various kinds of data for CPU processing. The HDD 103 stores the OS and application programs. The graphics processing unit 104 is connected to a monitor 11 to display images on the monitor 11 under the control of the CPU 101. The input device interface 105 is connected to a keyboard 12 and a mouse 13 to transfer signals from the keyboard 12 and the mouse 13 to the CPU 101 via the bus 107. The communication interface 106 is connected to the network 10, and is designed to communicate data with other devices via the network 10.

The above hardware configuration realizes the processing functions of this invention. Although FIG. 3 shows the hardware configuration of the information server 100, the central server 200, the core systems 21, 22, 23, 24, . . . , and the clients 31, 32, 33, . . . have the same hardware configuration.

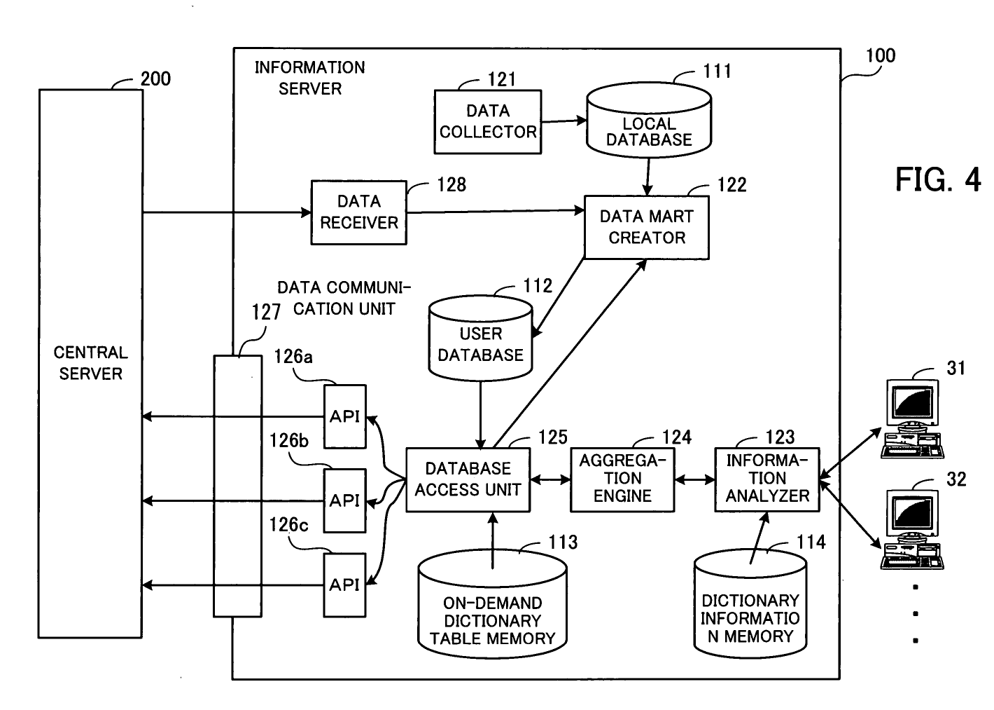

FIG. 4 is a functional block diagram of the information server 100. The information server 100 has a local database 111, a user database 112, an on-demand dictionary table memory 113, a dictionary information memory 114, a data collector 121, a data mart creator 122, an information analyzer 123, an aggregation engine 124, a database access unit 125, a central server Application Program Interfaces (API) 126a, 126b, and 126c, a data communication unit 127, and a data receiver 128.

The local database 111 is used to store data that is collected from the core systems 21, 22, 23, 24, . . . .

The user database 112 is used to store user-specified data out of the data being stored in the local database 111.

The on-demand dictionary table memory 113 is used to store an on-demand dictionary table composed of information on all databases of this system. For each database, the following information is registered in this on-demand dictionary table.
Table names identifying data tables.
Location information of data tables (whether the data tables exist in the local database 111 or somewhere via the central server 200).
Access information to the local database 111 (connection information to data sources which is specified to interfaces in order to access the data sources (host names, etc.)).
Access information to the central server 200 (location information of the central server, which is required for executing a central server API (host name etc.)).
Identifiers and attribute information of data sources corresponding to data tables (for example, database names, schema names, item names, and data types in a case of a Relational DataBase (RDB)).

The dictionary information memory 114 is used to store information (dictionary) regarding data items of accessible data tables. As accessible data tables, there are the data tables in the user database 112 and the data tables (virtual data tables) in the central server 200. The data tables in the central server 200 are virtually provided and do not exist actually. When an access is made to a data table in the central server 200, the central server 200 obtains data corresponding to target data in the data table, from the core systems 21, 22, 23, 24, . . . , and returns the data to the information server 100.

The data collector 121 collects data from the core systems 21, 22, 23, 24, . . . at prescribed timing in batch processing. The data collector 121 processes the collected data with ETL tool or the like, and stores the processed data in the local database 111.

The data mart creator 122 extracts user-specified data from the local database 111, and arranges and stores the extracted data in the user database 112.

The information analyzer 123 transmits a list of accessible data tables to the clients 31, 32 . . . . When receiving an analysis request from a client 31, 32, . . . , the information analyzer 123 issues a data acquisition request for data required for the analysis to the aggregation engine 124. Upon reception of data returned from the aggregation engine 124, the information analyzer 123 analyzes the data according to the user request, and transmits an analysis result to the client 31, 32, . . . .

The aggregation engine 124 creates a Structured Query Language (SQL) command in response to a data acquisition request from the information analyzer 123. The aggregation engine 124 gives the created SQL command to the database access unit 125. In addition, upon reception of data returned from the database access unit 125, the aggregation engine 124 gives the returned data to the information analyzer 123 altogether.

When receiving an SQL command from the aggregation engine 124, the database access unit 125 analyzes the SQL command to detect the table name of a data table storing the requested data. In addition, the database access unit 125 retrieves location information of the data table storing the requested data, from the on-demand dictionary table being stored in the on-demand dictionary table memory 113. When the data table exists in the local user database 112, the database access unit 125 acquires data from the user database 112. When there are some data tables in the central server 200 that store the requested data, the database access unit 125 decomposes the received SQL command into SQL commands each for accessing each of the data tables. That is, there is a case where requested data is stored in some data tables of the central server 200. In this case, the database access unit 125 creates SQL commands each for accessing each data table, and issues the created SQL commands to the central server APIs 126a, 126b, and 126c.

The central server APIs 126a, 126b, and 126c are API functions to request the central server 200 to provide data. The central server APIs 126a, 126b, and 126c drive in response to SQL commands output from the database access unit 125. Each central server API 126a, 126b, 126c transforms an SQL command received from the database access unit 125 into a data request to the central server 200, and transmits the data request to the central server 200 via the data communication unit 127.

The data communication unit 127 performs data communication via the network 10 with Transmission Control Protocol (TCP)/Internet Protocol (IP).

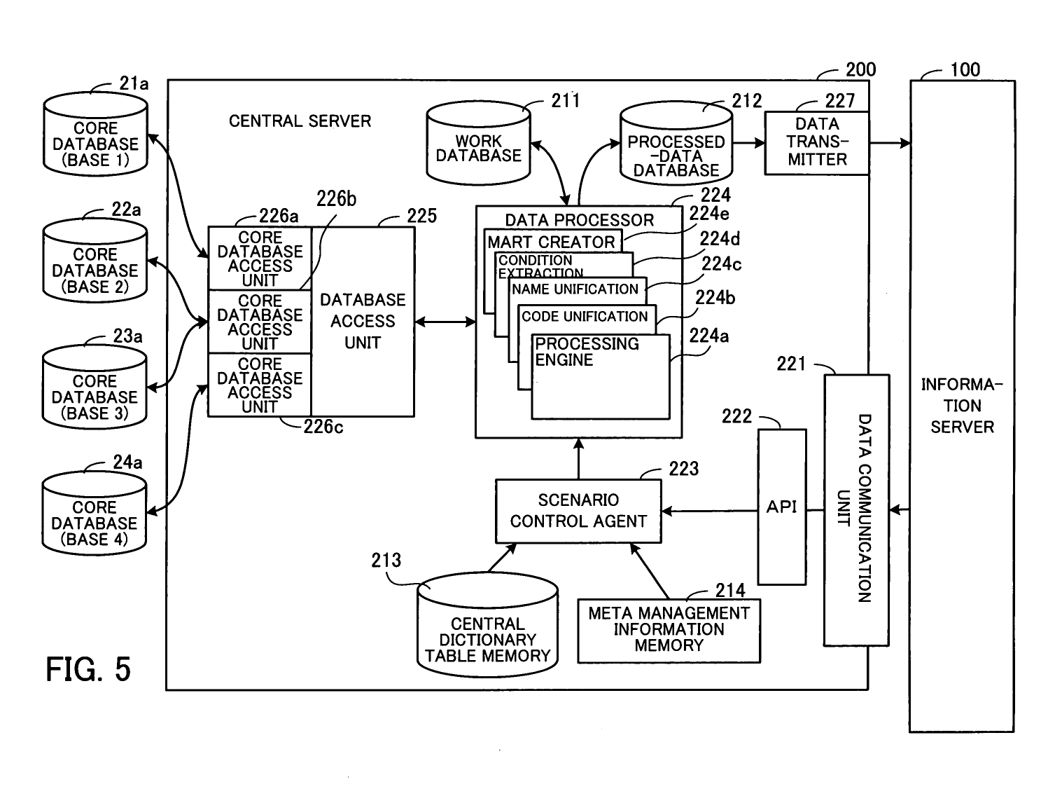

FIG. 5 is a functional block diagram of the central server. The central server 200 has a work database 211, a processed-data database 212, a central dictionary table memory 213, a meta management information memory 214, a data communication unit 221, an API 222, a scenario control agent 223, a data processor 224, a database access unit 225, core database access units 226a, 226b, and 226c, and a data transmitter 227.

The work database 211 is used to temporarily store data at the time of data processing.

The processed data database 212 is used to store data processed by the data processor 224.

The central dictionary table memory 213 is used to store information (central dictionary table) on the data tables in the core databases 21a, 22a, 23a, 24a, . . . of the core systems 21, 22, 23, 24, . . . . The central dictionary table stores the following information.
Information associating virtual data table names and scenario files.
Information managing table names and item names in the core databases of which data is extracted.
Information managing a condition value for each item.
Information managing where to store resultant data of data mart.

The meta management information memory 214 is used to store information (meta management information) indicating where data sources to be accessed, such as schema, data tables, and items, exist. The meta management information includes the following information.
Management information for scenario files.
Scenario files instructing code unification procedures.
Scenario files instructing processing methods (merging or operation of extraction results).

The data communication unit 221 performs data communication via the network 10 with TCP/IP.

The API 222 is an interface for recognizing data requests from the information server 100.

When receiving an SQL data request from the information server 100, the scenario control agent 223 determines a scenario indicating locations of requested data and a process to be performed on the data, with reference to the central dictionary table in the central dictionary table memory 213 and the meta management information in the meta management information memory 214. Then the scenario control agent 223 issues an instruction for acquiring and processing data according to the determined scenario, to the data processor 224.

The data processor 224 acquires data from the core systems 21, 22, 23, 24, . . . and processes the data. Specifically, the data processor 224 outputs a data acquisition request to the database access unit 225 in response to an instruction from the scenario control agent 223. Then the data processor 224 receives data from the database access unit 225 and processes the data according to a scenario. To process the data, the data processor 224 has a plurality of scenario engines 224a, 224b, 224c, 224d, and 224e.

The data processing unifies different data from different bases in terms of name, attribute, code system. Although this is similar to a conventional ETL-like scheme, this invention is designed to obtain and process only requested data according to necessity, which is different from the ETL-like scheme. When only latest data in a core system is required, an amount of the data is little and so loads on the core system are suppressed as low as possible.

The scenario engine 224a is a processing engine with a control function of entire processing to be performed according to a scenario. The scenario engine 224b has a function of unifying different management codes when the core systems assign the different management codes to the same product. The scenario engine 224c has a function of unifying different customer names when the core systems write different names for the same customer. The scenario engine 224d has a function of detecting conditions for acquiring data from an SQL data request. The scenario engine 224e has a function of arranging acquired data according to a user request.

The data processor 224 processes data with the functions of the scenario engines 224a to 224e. Data generated during the data processing is temporarily stored in the work database 211. Data finally obtained by the data processing is stored in the processed-data database 212.

The database access unit 225 instructs the core database access units 226a, 226b, and 226c to acquire data from the core databases 21a, 22a, 23a, 24a, . . . , according to requests from the data processor 224. Then the database access unit 225 returns data acquired from the core database access units 226a, 226b, and 226c, to the data processor 224.

The core database access units 226a, 226b, and 226care remote access functions provided as the functions of managing the core databases 21a, 22a, 23a, 24a, . . . . The core database access units 226a, 226b, and 226c access the core systems 21, 22, 23, 24 according to instructions from the database access unit 225 to acquire data from the core databases 21a, 22a, 23a, 24a, . . . of the core systems 21, 22, 23, 24. Then the core database access units 226a, 226b, and 226c give the acquired data to the database access unit 225. The database access unit 225 gives the received data to the data processor 224.

The data transmitter 227 transmits data being stored in the processed-data database 212 to the information server 100 with a communication system such as File Transfer Protocol (FTP) when the data processor 224 finishes the data processing.

A procedure for using real-time information in the system shown in FIGS. 4 and 5 will be now described. The following procedure realizes combining and using data in the local database 111 of the information server 100 and data in the core systems 21, 22, 23, 24, . . . . In the following explanation, it is assumed that a user uses the client 31.

When the user needs to conduct data analysis using latest data being stored in the core systems 21, 22, 23, and 24, the user accesses the information server 100 from the client 31. In the information server 100, the information analyzer 123 returns a list of data tables storing accessible data to the client 31, thereby displaying the list of data tables on the monitor of the client 31.

The user selects one or more attributes of data to be analyzed (for example, certain data items in a data table), on the screen of the client 31. Then the client 31 sends an analysis request for analyzing the selected data to the information server 100.

In the information server 100, the information analyzer 123 receives the analysis request from the client 31. The information analyzer 123 gives a data acquisition request for the data to be analyzed, to the aggregation engine 124.

Upon reception of the data acquisition request from the information analyzer 123, the aggregation engine 124 issues an SQL command required for the data utilization to the database access unit 125. When the database access unit 125 searches the on-demand information dictionary table and finds that the target data specified by the SQL command is already in a data table in the user database 112, the database access unit 125 requests the data mart creator 122 to extract the data specified by the data acquisition request, from the local database 111. Then the data mart creator 122 extracts the target data from the local database 111 and saves it in the user database 112. The database access unit 125 then accesses the user database 112 and acquires the data.

When the target data specified by the SQL command is in data tables in the central server 200 (that are virtual data tables and their substances (real tables) exist in core databases), on the other hand, the database access unit 125 decomposes the received SQL command into SQL commands each for accessing each of the data tables, in order to search the core databases for the data. Then the database access unit 125 issues a data request to the central server 200 via the APIs 126a, 126b, and 126c by using the created SQL commands.

The central server 200 always has the scenario control agent 223. The scenario control agent 223 refers to the dictionary information based on a received SQL command to specify where the real tables exist in the core systems. In addition, the scenario control agent 223 specifies a scenario to be conducted, based on the SQL command. The scenario control agent 223 instructs the data processor 224 to obtain and process data according to the scenario.

The data processor 224 acquires data from the core databases according to the specified scenario. Specifically, the data processor 224 makes data acquisition requests to the database access unit 225. The database access unit 225 drives core database access units corresponding to the core databases to be accessed, in response to the requests, and then the core database access units obtain only requested data from the core databases. The acquired data is given to the data processor 224 via the database access unit 225.

The data processor 224 processes the acquired data according to the scenario, by using the scenario engines 224a, 224b, 224c, 224d, and 224e. When the scenario engines complete the data processing, the processed data is stored in the processed-data database 212 in a file in a data format such as Comma Separated Values (CSV) data format or Data Definition Language (DDL) format.

The file being stored in the processed-data database 212 is transmitted with FTP or by disk sharing to the information server 100 by the data transmitter 227. The transmitted file is received by the data mart creator 122. The data mart creator 122 temporarily creates a data table for user inquiries in the user database 112. When the data table is created, the database access unit 125 accesses the user database 112 to extract data. The database access unit 125 gives the extracted data to the aggregation engine 124.

The aggregation engine 124 aggregates the data received from the database access unit 125, and gives the resultant to the information analyzer 123. The information analyzer 123 analyzes the received data and transmits the analysis result to the client 31.

In this way, data in the core systems and data in the information server are combined and used in real-time. In addition, required data can be collected from different bases according to necessity.

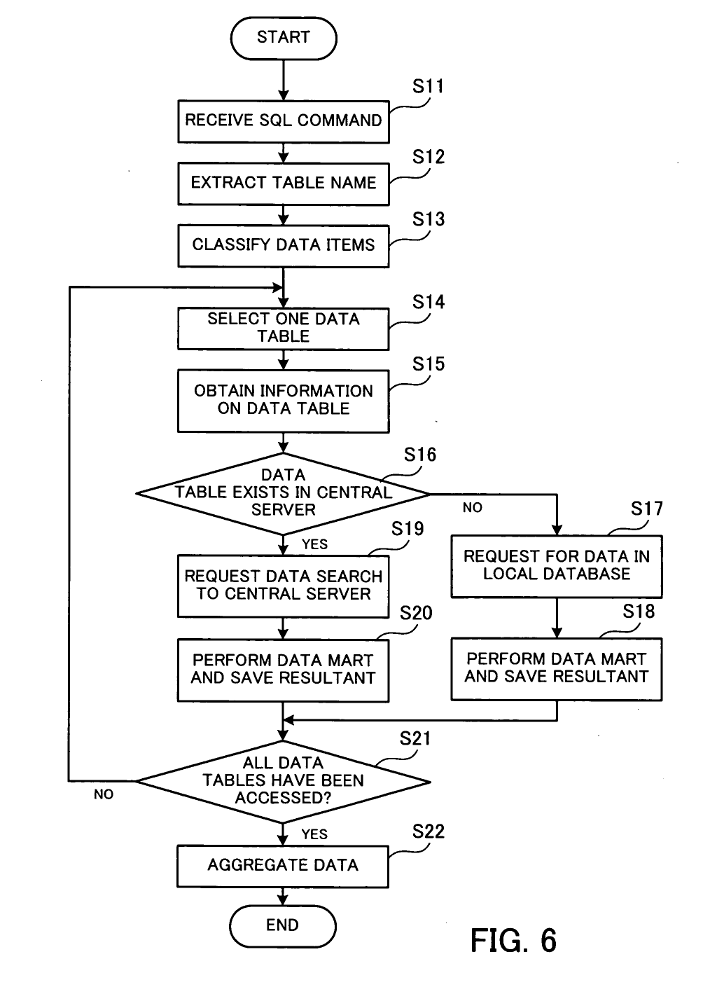

A data aggregation process to be performed by the information server 100 will be now described in detail with reference to FIG. 6. This process starts when the aggregation engine 124 issues an SQL command.

(Step S11) The database access unit 125 receives an SQL command from the aggregation engine 124. This SQL command represents an inquiry made by the user on Graphical User Interface (GUI). An SQL command is made up of definition information of target data items (names and table names of search items), conditions for searching for data of the items, and an aggregation method.

(Step S12) The database access unit 125 analyzes the SQL command to extract table names being selected.

(Step S13) The database access unit 125 analyzes the data items and their search conditions specified by the SQL command to classify the data items into corresponding data tables.

(Step S14) The database access unit 125 selects one data table for which a process after step S15 has not been performed, out of the detected data tables.

(Step S15) The database access unit 125 searches the on-demand dictionary table with the table name of the selected data table as a key, in order to find location information and access information regarding the data table corresponding to the key.

(Step S16) The database access unit 125 determines whether the detected location information indicates that the data table exists in the central server 200. When the data table exists in the central server 200, this process goes on to step S19. When the data table exists in the local database 111, the process goes on to step S17.

(Step S17) The database access unit 125 executes a data source access interface based on the access information to the local database 111, which is detected from the on-demand dictionary table, in order to instruct the data mart creator 122 to extract data from the data table.

(Step S18) The data mart creator 122 searches the local database 111, and performs data mart on a search result, and stores the resultant in the user database 112. Then the process goes on to step S21.

(Step S19) The database access unit 125 modifies the SQL command to have identifiers being managed by the central server 200, and gives it to an API 126a, 126b, 126c for accessing the central server 200, thereby requesting data search.

(Step S20) The data mart creator 122 performs data mart on the search result received from the central server 200, and stores the resultant in the user database 112.

(Step S21) The database access unit 125 determines whether a process from step S15 to S20 is performed for all data tables detected in step S13. When this determination results in No, the process goes back to step S14. When this determination results in Yes, the process goes on to step S22.

(Step S22) The database access unit 125 gives data being stored in the user database 112 to the aggregation engine 124. The aggregation engine 124 aggregates the data.

As described above, even when a data table to be accessed exists in the local database 111 or in accessible core databases via the central server 200, the user can aggregate data unconsciously.

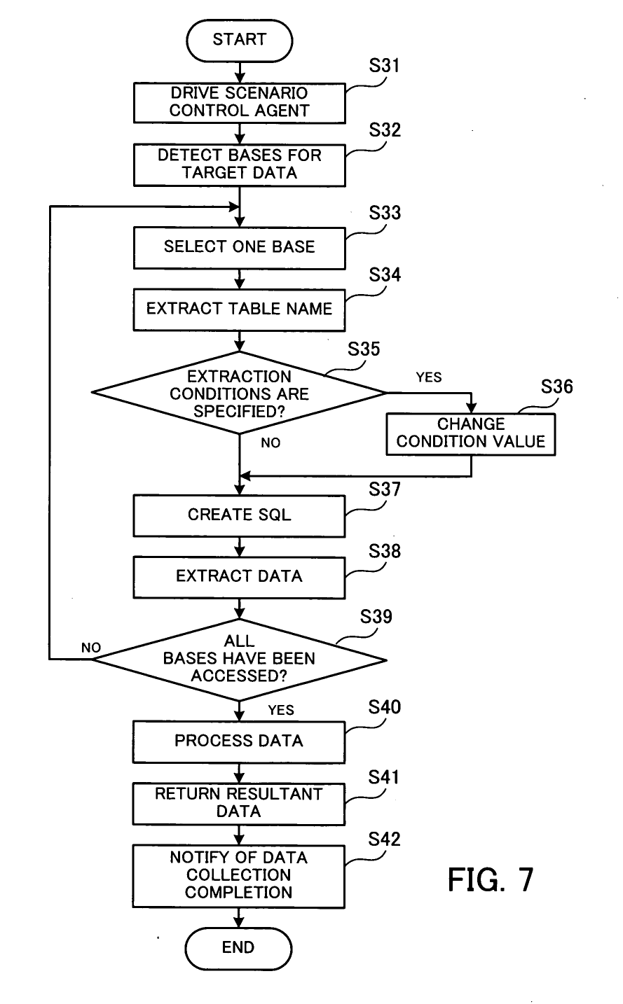

A data provision process from the central server 200 to the information server 100 will be described with reference to FIG. 7.

(Step S31) The scenario control agent 223 specifies a scenario to be executed, based on an SQL command received from the information server 100, and extracts a corresponding scenario file from the meta management information memory 214.

(Step S32) The scenario control agent 223 searches the central dictionary table for information on core databases (bases) storing target data. (Step S33) The scenario control agent 223 selects one base.

(Step S34) The scenario control agent 223 extracts the data table name being used in the selected base. That is, since a scenario includes information indicating what table name/item name are used in a base, the scenario control agent 223 can recognize the table name of a data table storing the target data from the scenario file.

(Step S35) The scenario control agent 223 determines whether the SQL command received from the information server 100 specifies conditions for extracting data. When the data extraction conditions are specified, the process goes on to step S36. When the data extraction conditions are not specified, the process goes on to step S37.

(Step S36) The scenario control agent 223 converts a condition value of the data extraction conditions set in the scenario, into a condition value of the extraction conditions indicated by the SQL command.

(Step S37) The data processor 224 creates an SQL command to extract data from the core database to be accessed.

(Step S38) The data processor 224 executes the SQL command created in step S37 to extract the data from the core database.

(Step S39) The scenario control agent 223 determines whether a process from steps S33 to S38 has been performed for all bases. When this determination results in No, the process goes back to step S33. When the determination results in Yes, the process goes on to step S40.

(Step S40) The data processor 224 processes the data extracted from the core databases, according to the scenario. For example, unification of product codes, name identification, merging, etc are performed.

(Step S41) The data processor 224 performs data mart according to the scenario, and stores the resultant in the processed-data database 212. The data transmitter 227 then transmits the data being stored in the processed-data database 212, including data definition language (DDL) definition, to the information server 100.

(Step S42) The scenario control agent 223 notifies the database access unit 125 of the information server 100 of completion of on-demand data collection. Thereby the database -access unit 125 recognizes that data can be acquired from the user database 112.

In this way, the central server 200 collects data from core databases and transmits the data to the information server 100.

Next, a screen to be displayed on the client 31 and user operations on the screen will be described. When the user using the client 31 instructs the information server 100 to analyze data including latest data, the user first specifies the data to be analyzed, on the screen of the client 31.

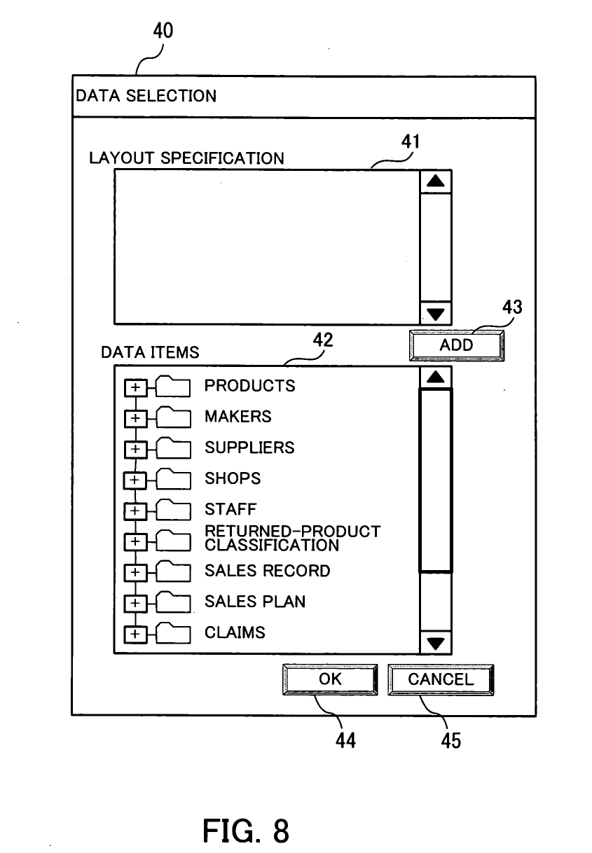

FIG. 8 shows a data selection screen being displayed on the client. The data selection screen 40 has a layout specification area 41 and a data item display area 42. The layout specification area 41 is a field for setting data items of which data are desired to be displayed on the screen.

The data item display area 42 is a field for displaying accessible data items. The data item display area 42 shows data items being stored in the local database 111 of the information server 100 and data items being stored in the core databases.

In this example, the data of “sales record” in the data item display area 42 is included in a virtual data table made up of data in the core systems which are located at different bases. In addition, the data of “shop” is included in a data table existing in the information server 100.

The user can select desired data to check, on this data selection screen 40, without considering where the data actually exists. Specifically, the user selects a desired data item on the data item display area 42, presses an ADD button 43, thereby setting the selected data item in the layout specification area 41. Then when the user presses an OK button 44, the data of the data item set in the layout specification area 41 is collected. Note that, when a CANCEL button 45 is pressed, the data selection screen 40 is closed without collecting data.

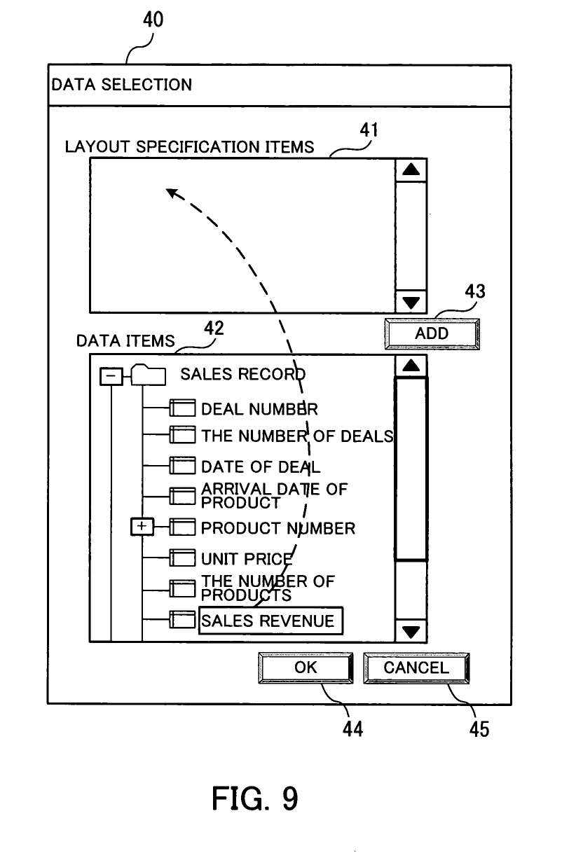

FIG. 9 shows a screen where sales revenue of a sales record table is selected. In this example, the data item display area 42 shows the data items of “sales record” and the data item “sales revenue” is being selected. By pressing the ADD button 43, “sales revenue” is displayed in the layout specification area 41. Then by pressing the OK button 44, an analysis result of sales revenue data is displayed on the screen.

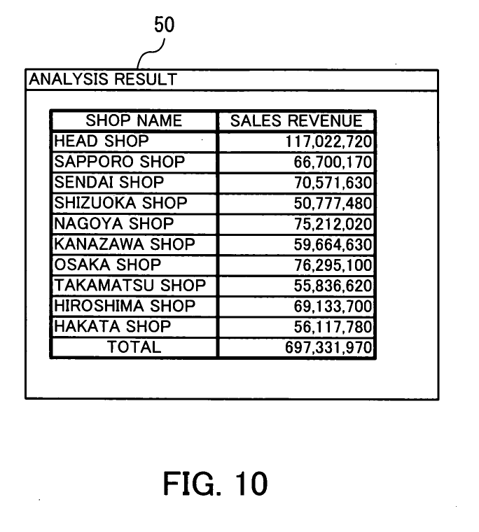

FIG. 10 shows an analysis result screen. In this figure, the latest sales record of each shop and a total amount are displayed in a table on the analysis result screen 50.

That is, the user can use the sales record tables of the core systems of the different shops (bases) as one sales record table.

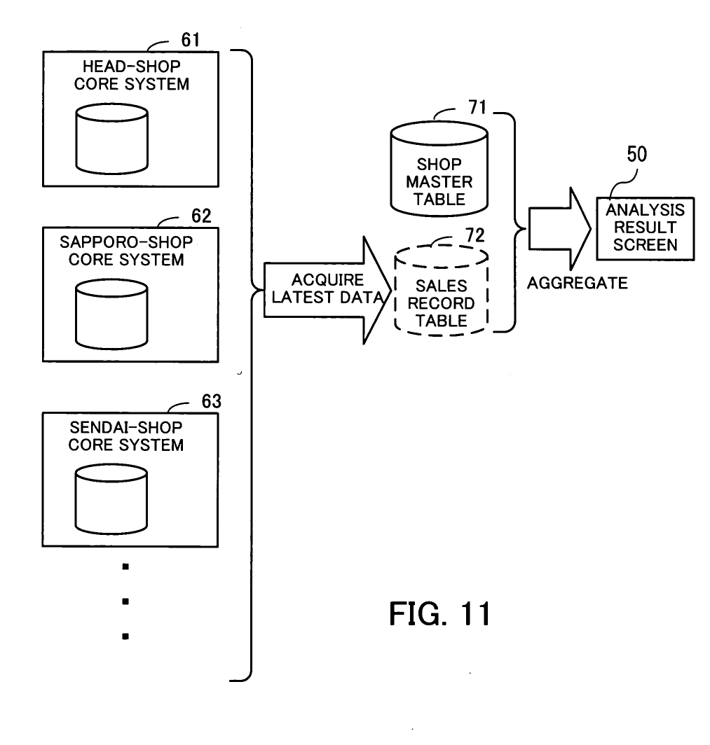

FIG. 11 is a conceptual view showing how to aggregate latest data. The core systems of all shops, including a head-shop core system 61, a Sapporo-shop core system 62, and a Sendai-shop core system 63, have the latest sales record tables. Shops of which sales data is aggregated are determined based on a shop master table 71, the latest data of the sales records is extracted from the core systems of the shops, and a sales record table 72 is created. Then the sales record of each shop is analyzed, and based on the shop master table 71 and the sales record table 72, an analysis result screen 50 is displayed.

An SQL decomposition process to be performed by the database access unit 125 will be now described in detail.

The SQL decomposition for obtaining the sales record data of each base in order to create the sales record table 72 as shown in FIG. 11 is performed as follows.

(First stage) A user makes a search request on the data selection screen 40 of the client 31, thereby requesting the information analyzer 123 of the information server 100 to collect data of a target data item (in this example, “sales revenue” of “sales record”) which is set in the layout specification area 41 of the data selection screen 40.

(Second stage) The information analyzer 123 searches the dictionary information memory 114. This result in obtaining such information that “sales revenue” of “sales record” specified by the user on the data selection screen 40 corresponds to an item “sales revenue” of a table “sales record”. Therefore, the information analyzer 123 recognizes that the user's request made on the data selection screen 40 is to add up the values of the item “sales revenue” of the “sales record” table, and requests the adding-up to the aggregation engine 124. In addition, the information analyzer 123 obtains from the dictionary information memory 114 attribute information, such as the data type and restrictions of the item, required for receiving or referring to returned data, and gives this information to the aggregation engine 124 as well.

The table name “sales record” being used at this stage of this process is a name that is given by the information server and is registered in the dictionary information memory 114 in order to identify the table, independently of specifications unique to each core system, and is not an identifier being used in a data source where the table actually exists.

(Third stage) The aggregation engine 124 obtains an aggregation result through a process of collecting and adding up the detailed data of the item “sales revenue” of the “sales record” table. For this adding-up operation, the aggregation engine 124 creates a following SQL command requesting for extracting the detailed data of the item “sale revenue” from the “sales record” table, in order to request the database access unit 125 to execute this command. “SELECT “sales revenue” FROM “sales schema”. “sales record””

Note that restriction conditions for this data search are actually added to this command.

In addition to the SQL execution request to the database access unit 125, the aggregation engine 124 informs the database access unit 125 of a return place for resultant data and its data type, by using the item attribute information given from the information analyzer 123.

(Fourth stage) The database access unit 125 executes the SQL command issued by the aggregation engine 124.

(4-1) The database access unit 125 finds based on the on-demand dictionary table memory 113 that the “sales record” table specified in the SQL command is actually a virtual data table in the central server 200.

(4-2) In this case, the database access unit 125 searches the on-demand dictionary table memory 113 for identifiers being used in the central server 200 corresponding to the table name “sales record” and the item name “sales revenue”, which are identifiers given by the information server. By this search, the database access unit 125 recognizes that the name of the virtual data table that is used in the central server is “sales record table” and the item name is “total sales revenue”.

(4-3) The database access unit 125 creates a following SQL command by replacing the table name and the item name included in the SQL command given from the aggregation engine 124 by the identifiers being managed by the central server 200, based on the information recognized at stage (4-2). “SELECT “total sales revenue” FROM “sales record table””

Note that restriction conditions for this data search are actually added to this command.

(4-4) The result of searching the virtual data table of the central server 200 according to the SQL command is received by the data mart creator 122 of the information server 100, and a table for user inquiries is temporarily created in the user database 112 to store the resultant data. Then the database access unit 125 extracts the result of execution of the SQL command given from the aggregation engine 124, from the created temporal table in the user database 112, and returns it to the aggregation engine 124. Therefore, before requesting the execution of the SQL command to the central server 200 at stage (4-3), the database access unit 125 obtains item attribute information, such as the data type and restrictions of the virtual data table “sales record table”, from the on-demand dictionary table memory 113, and determines the table name, the item name, and the data type of the temporal table to be created in the user database 112.

(4-5) The database access unit 125 specifies the SQL command created at stage (4-3) for searching the virtual data table in the central server 200 and definition information on a table to be created in the user database 112 for storing a result of executing the SQL command, which is determined at stage (4-4), and executes the central server API 126a, thereby requesting the SQL execution to the central server 200.

(Fifth stage) The scenario control agent 223 of the central server 200 decomposes the search SQL command for the virtual data table, which is given from the database access unit 125 of the information server 100, into a plurality of SQL commands each requesting data search in each base.

(5-1) The scenario control agent 223 of the central server 200 analyzes the SQL command received from the database access unit 125 of the information server 100 to determine a scenario to be executed, corresponding to the virtual data table name.

The scenario describes which items are used to create the items of the virtual data table, out of the items in the base systems being managed by the central dictionary table memory 213.

Specifically, to create an item “all-shop sales record” of the sales record table 72 which is a virtual data table, a corresponding scenario describes combining the detailed data of the sales record tables of the shops being managed by the core systems of the bases, that is, combining the detailed data of the item “shop sales revenue” of the “head-shop sales record” table of the head-shop core system 61, the detailed data of the item “shop sales revenue” of the “SAPPORO-shop sales record” table of the SAPPORO-shop core system 62, the detailed data of the item “shop sales revenue” of the “SENDAI-shop sales record” table of the SENDAI-shop core system 63, . . . .

These table names and item names described in the scenario are not the actual names being used in the data sources of the bases but are ones that are given for the tables of the bases as names for identifying the tables of the bases in the central server. That is to say, these table names and item names are usable only in the central server 200 by previously being registered in the central dictionary table memory 213.

(5-2) The scenario control agent 223 requests the database access unit 225 to search for the data of the table of each base recognized at stage (5-1), via the data processor 224. Specifically, the scenario control agent 223 creates an SQL for searching a table in each base to be given to the database access unit 225, as follows.

An SQL command to be issued to the database access unit 225 to search a base having the head-shop data is: “SELECT “shop sales revenue” FROM “head-shop sales record””.

An SQL command to be issued to the database access unit 225 to search a base having the SAPPORO shop data is: “SELECT “shop sales revenue” FROM “SAPPORO-shop sales record””.

To search for the other shop data, SQL commands is created for the corresponding bases in the same way. Although restriction conditions for extracting data from a core database are not added for simple explanation, conditions narrowing a search range, such as search for today, are actually added to the SQL commands.

(Sixth stage) The database access unit 225 executes each SQL command created at stage (5-2), thereby accessing a corresponding base.

(6-1) The database access unit 225 can obtain information that is unique to the data source of each base corresponding to the table name specified by an SQL created at stage (5-2), by searching the registered information of the central dictionary table memory 213 and the meta management information memory 214. Thereby it can be detected which base should be searched for the data.

(6-2) In a case where the “head-shop sales record” table of the head shop actually exists in the core database 21a of a base 1, such correspondence information that the table name identifier “head-shop sales record” used in the central server 200 is of a table actually existing in the core database 21a is registered in the meta management information memory 214. Further, such information that the core database 21a is an RDBMS of a special vendor and access interface information that is unique to the DBMS are also registered in the meta management information memory 214. Furthermore, such information that the item “sales revenue” of the table name identifier “head-shop sales record” being used in the central server 200 corresponds to an item “head-shop sales revenue” of a table “head-shop sales” in the actual base system is also registered in the meta management information memory 214.

Based on the information obtained from the meta management information memory 214, the database access unit 225 converts the received SQL command for the head shop search of stage (5-2) into an SQL command for searching the core database 21a via the core database access unit 226a corresponding to an RDBMS-specific interface of the core database 21a. The created SQL is: “SELECT “head-shop sales revenue” FROM “head-shop sales””.

(6-3) Each of an SQL command for searching the base of the SAPPORO shop and an SQL command for searching the base of the SENDAI shop is executed after being converted into an SQL command corresponding to the interface specific to the base in the same way. If a base does not have an RDBMS, the expression of a received SQL is converted to an expression suitable for the interface of the system, such as API, by using a core database access unit to perform search, and then the resultant is returned after being converted in an SQL format. Therefore, the above scheme enables searching various kinds of systems.

(Seventh stage) As described above, the scenario control agent 223 collects required detailed data of each base with the data processor 224, and creates final data resulted from executing the SQL issued from the information server 100. To create this resultant data, the database access unit 125 of the information server 100 changes the data type to conform to the structure of the temporal table for storing the resultant in the user database 112, which is determined at stage (4-4). In addition, the database access unit 125 creates a table definition statement (DDL definition) to be used for creating the temporal table and gives it to the data mart creator 122 of the information server 100 via the data transmitter 227.

(Eighth stage) The data mart creator 122 of the information server 100 creates the temporal table in the user database 112 according to the DDL definition, and stores the received resultant data.

(Ninth stage) The database access unit 125 of the information server 100 receives a notification indicating that the central server API 126a surly stores the result of executing the SQL at stage (4-5), in the temporal table of the user database 112. Then the database access unit 125 obtains data from the user database 112, converts the data into the data type that is demanded by the aggregation engine 124 at (third stage), and returns the resultant data to the specified return place.

Therefore, the aggregation engine 124 can obtain the detailed data of “sales revenue” of the “sales record” table requested at (third stage), create an aggregation result requested by the information analyzer 123 by performing the adding-up operation on the detailed data, and return it to the information analyzer 123.

The information analyzer 123 finally converts the aggregation result given from the aggregation engine 124 into a display format and returns it to the client 31, so that the client 31 can display the result to show the user.

As described above, the system according to this embodiment can treat more recent data (raw data). In addition, fixed data and unfixed data can be combined and analyzed. Further, since, like on-demand, desired data can be dynamically collected when its analysis is required, data can be collected more easily.

That is, data in the core systems and data in the information system can be combined in real-time, thus making it possible to use latest data, or real-time data. This is difficult to realize in prior art.

Furthermore, when core data exist in different bases, the data is very difficult to collect the data at a certain place in prior art. According to this embodiment, however, required information can be obtained according to necessity, so that a large amount of data is not necessary to collect in an information system. In addition, only data specified by a user can be collected in real-time, resulting in smaller loads on the core systems.

The processing functions described above can be realized by a computer. In this case, a program is prepared, which describes processes for the functions to be performed by the information server 100 and the central server 200. The program is executed by a computer, whereupon the aforementioned processing functions are accomplished by the computer. The program describing the required processes may be recorded on a computer-readable recording medium. Computer-readable recording media include magnetic recording devices, optical discs, magneto-optical recording media, semiconductor memories, etc. The magnetic recording devices include Hard Disk Drives (HDD), Flexible Disks (FD), magnetic tapes, etc. The optical discs include Digital Versatile Discs (DVD), DVD-Random Access Memories (DVD-RAM), Compact Disc Read-Only Memories (CD-ROM), CD-R (Recordable)/RW (ReWritable), etc. The magneto-optical recording media include Magneto-Optical disks (MO) etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer runs the program. The computer may run the program directly from the portable recording medium. Also, while receiving the program being transferred from the server computer, the computer may sequentially run this program.

According to this invention, when an access request to remote databases is made, the access request is decomposed into remote access requests each for accessing each of the remote databases, thereby accessing the remote accesses. Therefore, to collect data of a specified data item, a user does not need to input an access request for each remote database, resulting in realizing easy data collection work.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium storing a data collection program for aggregating data being dispersed on a network, the data collection program causing a computer to function as:
data information memory means for storing remote data information on data items of stored data of a plurality of remote databases being connected over the network;
information management means for displaying accessible data items based on the remote data information being stored in the data information memory means, and accepting an access request specifying a target data item to be accessed;
access request decomposition means for determining at least one remote database to be accessed, based on the access request accepted by the information management means, and decomposing the access request into remote access requests each for accessing each of the at least one remote database;
access means for accessing the at least one remote database according to the remote access requests created by the access request decomposition means, and extracting the data from the at least one remote database; and
aggregation means for aggregating the data extracted by the access means, and displaying an aggregation result.

2. The computer-readable recording medium storing the data collection program according to claim 1, wherein
the data information memory means further stores local data information on local data items of locally stored data of a local database,
the information management means displays the accessible data items based on the remote data information and the local data information being stored in the data information memory means, and accepts the access request specifying the target data item to be accessed,
the access request decomposition means creates a local data access request for accessing the local database when the access request accepted by the information management means specifies a local data item of the local database, and
the access means extracts the data from the local database according to the local data access request.

3. The computer-readable recording medium storing the data collection program according to claim 2, wherein the locally stored data is previously obtained by aggregating the stored data of the plurality of remote databases at prescribed timing and is saved in the local database.

4. The computer-readable recording medium storing the data collection program according to claim 1, wherein the access means obtains the data from the at least one remote database via a central server performing prescribed processes on the data extracted from the at least one remote database.

5. The computer-readable recording medium storing the data collection program according to claim 4, wherein the access means transmits to the central server a data acquisition request including information specifying a scenario describing the prescribed processes, and receives the data processed according to the scenario specified, via the central server.

6. A data collection apparatus for aggregating data dispersed over a network, comprising:
data information memory means for storing remote data information on data items of stored data of a plurality of remote databases being connected to the network;
information management means for displaying accessible data items based on the remote data information being stored in the data information memory means, and accepting an access request specifying a target data item to be accessed;
access request decomposition means for determining at least one remote database to be accessed, based on the access request accepted by the information management means, and decomposing the access request into remote access requests each for accessing each of the at least one remote database;
access means for accessing the at least one remote database according to the remote access requests created by the access request decomposition means, and extracting the data from the at least one remote database; and
aggregation means for aggregating the data extracted by the access means, and displaying an aggregation result.

7. A data collection method for aggregating data dispersed over a network with a computer, wherein a computer comprises:
displaying accessible data items based on remote data information on data items of stored data of a plurality of remote databases being connected over the network, and accepting an access request specifying a target data item to be accessed;
determining at least one remote database to be accessed, based on the access request accepted, and decomposing the access request into remote access requests each for accessing each of the at least one remote database;
accessing the at least one remote database according to the remote access requests created, and extracting the data from the at least one remote database; and
aggregating the data extracted, and displaying an aggregation result.
